(19) United States
(12) Patent Application Publication
(10) Pub. No.: US 2006/0105092 A1
(43) Pub. Date: May 18, 2006

(54) Trans-fatty acid free shortening

(75) Inventor: Miranda Miller, Arlington Heights, IL (US)

Correspondence Address: FITCH EVEN TABIN & FLANNERY, 120 S. LASALLE STREET, SUITE 1600, CHICAGO, IL, 60603-3406, US

(73) Assignee: Kraft Foods Holdings, Inc.

(21) Appl. No.: 10/986,604

(22) Filed: Nov. 12, 2004

(51) Int. Cl. A23D 7/06

(52) U.S. Cl. 426/604

(57) ABSTRACT

The invention is directed to a fat composition having a mesophase matrix with characteristics of a shortening. The fat composition may be produced from a blend of an oil phase and an emulsifier mixture. The oil phase preferably is at least one oil, and the emulsifier mixture is a plurality of emulsifiers. In another embodiment, the invention is directed to a food product comprising the fat composition. In this form, the fat composition may replace a traditional shortening used in the food product. The fat composition having the mesophase matrix generally contains low levels of trans-unsaturated fatty acids and low levels of saturated fatty acids.

### FIELD OF THE INVENTION

The invention is generally related to an oil composition that can be used as a shortening. More particularly, the invention is related to an oil composition that can be used as a shortening having a mesophase structure with low levels of trans-unsaturated fatty acids and low levels of saturated fatty acids.

### BACKGROUND OF THE INVENTION

A shortening is a fat that may contain trans-unsaturated fatty acids or saturated fatty acids. Such fatty acids have been linked in recent years to health concerns; however, such fats are generally necessary in the shortening to provide a solid fat content and desired melting profile.

To form the typical shortening, a liquid vegetable oil or an animal fat is often used; however, these sources of fat frequently contain high levels of the trans-unsaturated or saturated fatty acids. For instance, animal fats, such as lard and tallow, typically have a high proportion of saturated fatty acids. Similarly, some plant fats, such as palm or coconut oils, also have high levels of saturated fatty acids and may further include trans-unsaturated fatty acids, which may be generated in the hardening process that converts the oil into a form suitable for a shortening. Hardening a vegetable oil may be completed by hydrogenation. While hydrogenation creates the hardness and melting profiles suitable for the shortening, the process can also convert some unsaturated fatty acids from a cis-orientation to the undesired trans-orientation.

Much data in recent years has linked trans-unsaturated fatty acids and saturated fatty acids to a variety of health concern. One such health concern, high cholesterol, may be caused, in part, by a diet that includes high levels of such fatty acids. Mounting evidence further suggests that, in some individuals, high cholesterol may contribute to increased risk of heart attacks, strokes, and other tissue injuries.

In recent years, many efforts have been made to reduce the fat content of various foods. However, when the fat level is reduced in conventional foods, the organoleptic properties may be adversely affected because the oiliness and slipperiness (i.e. mouthfeel) imparted by the fat particles suspended in the food product are effectively lost. In addition, other mouthfeel and textural properties, such as richness and creaminess, may also be adversely affected by the removal or reduction of such fats. Furthermore, flavor properties may be adversely affected because the distribution of flavor molecules between the lipid phase and the aqueous phase is altered. As a result, such reduced-fat food products may not be appealing to the consumer because of their mouthfeel, flavor and organoleptic properties.

As a result, there is a desire to provide a fat that can be used as a shortening, but without substantial amounts of trans-unsaturated fatty acids. There is also a desire to provide a fat, which can be used as a shortening, which is produced without the use of hardstock triglycerides that contain high levels of saturated fatty acids.

### SUMMARY OF THE INVENTION

The invention is directed to an oil composition having a mesophase matrix that provides characteristics of a shortening. The oil composition may be produced from a combination of an oil phase and an emulsifier mixture. The oil phase contains at least one oil; and preferably a vegetable oil, and most preferably an unhardened vegetable oil. The emulsifier mixture is a plurality of emulsifiers. The oil composition having the mesophase matrix generally contains low levels of trans-unsaturated fatty acids (generally less than about 5 percent and preferably less than about 1 percent) and is low in saturated fatty acids (generally less than about 20 percent and preferably less than about 10 percent).

In another aspect of this invention, a mesophase matrix may be used to further harden a more highly saturated fatty acid-containing vegetable oil. Such vegetable oils include for example palmitic fats (such as palm oil and cottonseed oil) and lauric fats (such as coconut oil and palm kernel oil). The mesophase matrix may act synergistically with the saturated fatty acid matrix of the vegetable oil to strengthen and convert the liquid or soft plastic fat to a harder plastic shortening. The level of saturated fatty acids in these oils is generally at least about 25% and preferably less than 65%. Once structured with mesophase, they can replace shortenings having between 50% and 90% saturated fatty acids.

In one aspect, the emulsifier mixture includes a first emulsifier having a low HLB value between about 2 and about 6 and a second emulsifier having a high HLB value between about 9 and about 22. The total composition may include at least about 3% of the first or low HLB emulsifier, and preferably from about 3% to about 10% of the first or low HLB emulsifier. The total composition may further include at least about 1% of the second or high HLB emulsifier, and preferably from about 1% to about 7% of the second or high HLB emulsifier. It is preferred that the low HLB emulsifier contain saturated fatty acid esters and have a melting point above 100° F. The preferred low HLB emulsifier is selected from the group consisting of distilled monoglycerides, mono- and diglyceride blends, lactic acid esters of mono and diglycerides, or mixtures thereof. It is preferred that the high HLB emulsifier contain saturated fatty acid esters and have a melting point above 100° F. The preferred high HLB emulsifier is selected from the group consisting of sodium and calcium stearoyl lactylate, mono-, di- and tri-fatty acid esters of sucrose, or mixtures thereof.

Preferably, the emulsifier mixture and oil phase form a gel having a strength of at least about 50 grams, and preferably at least about 200 grams, as measured using a TA-XT2 Texture Analyzer (Texture Technologies Corporation, Scarsdale N.Y.) equipped with a ½ inch round probe penetrating to a depth of 10 mm. At this strength, the emulsifier mixture and oil preferably form a soft plastic gel. Although all the emulsifier and oil gels of the present invention soften somewhat when they are stirred, it is preferred that the shortening remains homogeneous and does not break down into an oil phase and gel phase. Such characteristics are suitable for use of the mixture as a shortening.

The oil composition having the mesophase structure may be formed by combining the emulsifier mixture with at least one oil to form an oil composition. The oil composition is then heated to a temperature effective for melting the emulsifier mixture; generally, the composition is heated to a temperature of at least about 140° F., or to a temperature at which the mixture forms a clear melt. Once the emulsifier mixture is melted, a blended oil composition is formed. After heating, the blended oil composition is cooled so that a gel or a mesophase may form.

In one form, the oil phase may include more than 50% mono-unsaturated fatty acids because such oils generally contain low levels of trans-unsaturated fatty acids and saturated fatty acids. Such oils may also contain lower levels of poly-unsaturated fatty acids which confers additional stability to the oil. However, it is preferred that the oil phase comprises at least one high mono-unsaturated oil, such as a high-oleic canola oil or high oleic sunflower oil. Preferably, the oil composition includes less than about 1% of trans-unsaturated fatty acids and less than about 10% of saturated fatty acids. Alternatively, the oil phase may comprise a blend of oils. Preferably, a high mono-unsaturated oil is blended with a more highly saturated oil to dilute the saturated fatty acids. The oil composition of the blend preferably includes at least about 25% less saturated fatty acids, and more preferably at least about 50% less saturated fatty acids, than the highly saturated oil. In another embodiment, the invention is directed to a food product comprising the oil composition. In this form, the oil composition may replace a traditional shortening used in the food product. In some applications, a crystalline polyol is included to mimic some of the mouthfeel effects of the trans fat or saturated fat that is being replaced.

### DETAILED DESCRIPTION

In one embodiment, an oil composition having a mesophase matrix or gel having characteristics of a shortening is disclosed. Preferably, the oil composition is produced from the combination of an oil phase and an emulsifier mixture. The oil phase contains at least one oil, which preferably may be a vegetable oil, and most preferably is an unhardened vegetable oil. The emulsifier mixture is a plurality of emulsifiers. In another embodiment, a food product comprising the oil composition is disclosed. In this form, the oil composition may replace a traditional shortening used in the food product. The oil composition having the mesophase matrix generally contains low levels of trans-unsaturated fatty acids and is lower in saturated fatty acids than the shortening it is replacing.

Mesophase structures are described in detail in U.S. Pat. Nos. 6,025,006; 6,068,876; and 6,033,710; which are assigned to the same applicant and incorporated herein by reference. In general, a mesophase is neither an aqueous phase nor an oil phase, but a separate phase that is a liquid crystalline phase of both hydrophobic and hydrophilic character. In the above referenced patents, the mesophase is dispersed throughout an aqueous medium. In one form, the mesophase typically contains oil droplets, which appear in a narrow range of sizes as relatively small-sized oil droplets dispersed in an aqueous gel phase. The mesophase structure can be a stabilized emulsion that includes several emulsifiers, an oil phase, and an aqueous phase. Other forms of the mesophase may include three emulsifiers dispersed in an aqueous phase. While not wishing to be limited by theory, a typical mesophase structure may be formed because, in some instances, there is generally no lipid in the composition for the emulsifiers to interface with; as a result, a structure forms spontaneously that attempts to bury the lipophilic tails with a bi-layer or other crystalline structure that is formed.

Because a shortening typically does not include an aqueous phase (i.e. water content less than about 1%), the previous mesophase formulations are not sufficient for transforming an oil into a form suitable for use as a shortening. Again, not wishing to be limited by theory, it is believed that the inventive compositions, in one aspect, form a mesophase structure that generally attempts to bury the hydrophilic head groups within the structure, rather than the lipophilic tails of the previous mesophase structures. The inventive mesophase formulation is formed from a mixture of emulsifiers blended with the oil phase. It has been discovered that mixtures of emulsifiers in the oil phase can form such mesophase structures, even without the presence of an aqueous phase. The blended oil and emulsifier mixtures, as a result, achieve shortening-like characteristics without using the hydrogenation process.

The oil compositions having the mesophase preferably include low levels of trans-unsaturated fatty acids and low levels of saturated fatty acids. In one embodiment, the mesophase oil compositions preferably have less than about 5% trans-unsaturated fatty acids and less than about 20% saturated fatty acids. In another embodiment, the mesophase oil compositions preferably have less than about 5% trans-unsaturated fatty acids and at least about 25% less saturated fatty acids than the shortening they are replacing. Such levels are achieved, in one embodiment, because the oil develops characteristics of a shortening without the use of hydrogenation. By elimination of the hydrogenation, the mesophase oil compositions do not have the trans-unsaturated fatty acids. Moreover, if the mesophase matrix is formed within a high-stability, low-saturate oil, such as canola oil, high-oleic canola oil, or high oleic sunflower oil, a healthy alternative to the typical shortening is achieved because such oils do not have high levels of the saturated fatty acids. While high oleic canola and high oleic sunflower oils are an example of preferred oils, other unhardened vegetable oils having low levels of saturated fatty acids (generally less than about 20 percent) may be used as well. For example, the oil phase, alternatively, may be any oil or combination of oils having more mono-unsaturated fatty acids than either saturated fatty acids or poly-unsaturated fatty acids. Other oils that may be useful include olive oil (70% mono, 16% poly, 14% sat) and peanut oil (48% mono, 34% poly, 18% sat).

To form the mesophase structure within the oil, the mixture of emulsifiers comprises at least one high HLB and at least one low HLB emulsifier. In general, such mixture forms a firm mesophase structure or gel in the oil; however, the combination, ratio, and level of such emulsifiers impacts the strength and stability of the matrix or gel, which is further described below. Preferably, the emulsifier mixture and oil phase form a gel having a strength of at least about 50 grams, and preferably at least about 200 grams, as measured using a TA-XT2 Texture Analyzer (Texture Technologies Corporation, Scarsdale N.Y.) equipped with a ½ inch round probe penetrating to a depth of 10 mm.

The HLB value is one method of classifying emulsifiers. This classification method groups emulsifiers according to their stabilizing efficiency for a particular type of emulsion. The HLB value categorizes emulsifiers by a hydrophile-lipophile balance. For example, emulsifiers with a low HLB value (i.e., about 4 to about 6) are suitable for preparing water-in-oil emulsions. Emulsifiers with a high HLB value (i.e., about 9 to about 22), on the other hand, are suitable for oil-in-water emulsions. In between, emulsifiers having an intermediate or medium HLB value (i.e., about 6 to about 9) may be suitable for either type of emulsion depending upon the oil/water ratio, temperature, and other conditions. The HLB characterization is based upon the idea that for a given oil and water system, there is an optimum balance between molecular hydrophilic and lipophilic character that leads to increased emulsification efficiency.

In one form of the mesophase oil compositions, mixtures of sodium stearoyl lactylate (SSL), and distilled monoglycerides (MG/DG) may be suitable as the emulsifier mixture to form the mesophase. However, mixtures of other emulsifiers such as lactic acid esters of mono- and diglycerides, and mono-, di- and tri-fatty acid esters of sucrose, may also be used to form the mesophase. SSL is a high HLB emulsifier, and MG/DG is a low HLB emulsifier. Generally, a blend of at least two emulsifiers are added to the oil phase in which the mesophase is formed. In a preferred form, a combination of SSL and MG/DG is the emulsifier mixture. Preferably, it is desired that the emulsifier mixture form a mesophase structure that is firm and does not break down, become soft, or become pourable when stirred. Such characteristics are generally suitable for the oil composition to be used as a shortening. However, as will be further discussed below, the mesophase can be varied to achieve different characteristics for different applications.

It has been discovered that the total level of emulsifier may affect the strength of the matrix. For instance, it is preferred that the total composition include at least about 3% of the emulsifier mixture, and generally about 3% to about 15%. In general, higher levels of emulsifier produce a stronger matrix. It is most preferred, however, that the emulsifier mixture range from about 4% to about 12% of the total composition.

Preferably, a ratio between about 1:3 to about 3:1 of low HLB emulsifier to high HLB emulsifier is selected because such ratios form the desired firm gel that remains firm upon stirring. More specifically, in one embodiment, the total composition preferably includes a blend of about 6 to about 12 percent emulsifier mixture, having the above ratio of emulsifiers, mixed with about 88 to about 94 percent high-oleic canola oil. In another embodiment, the total composition preferably includes a blend of about 3 to about 12 percent emulsifier mixture, having the above ratio of emulsifiers, mixed with about 15 to about 97 percent of palmitic or lauric fat, and 0 to about 80 percent high-oleic canola oil. Such formulation produces acceptable results for use as a shortening. Generally, the total composition contains about 3 to about 10 percent of the low HLB emulsifier and about 1 to about 7 percent of the high HLB emulsifier. As previously discussed, such levels and ratios of emulsifiers produce a firm matrix that remains firm upon stirring.

As suggested by the previous discussion, the properties of the mesophase shortening can be tailored for different applications. For instance, by using emulsifiers with different lipophilic components, by varying the ratio of the emulsifiers in the mixture, or by altering the emulsifier to oil proportions a mesophase structure having varying characteristics is formed. For instance, varying the total amount of the emulsifier mixture generally affects mesophase strength as previously discussed. Varying the type of emulsifiers can produce structures that are breakable, pourable, oily, or firm when stirred. Altering the ratio of emulsifiers may produce structures that vary from being soft or runny when stirred to structures that remain gelled when stirred.

To form the mesophase structure, the emulsifier mixture is generally combined with the oil phase. The combination is then heated to a temperature effective to melt the emulsifiers. Preferably, the combination is heated to about 140° C. for about 2 minutes. (In some cases is may be necessary to heat to about 160° C. depending on the particular emulsifier blend. Emulsifiers with higher saturated fatty acid components, i.e. stearate and above, typically have a higher melting temperature.) After the emulsifiers are melted within the oil, the combination is allowed to cool so that a solid gel matrix or the mesophase is formed.

The mesophase oil compositions can be used in any application requiring a traditional shortening. Preferred uses include baked products or other food products that require a rich and creamy texture. When replacing the traditional shortening, the mesophase oil compositions provide the characteristics of a shortening but, as previously discussed, have low levels trans-unsaturated fatty acids and low levels of saturated fatty acids. For example, when used to replace partially hydrogenated oils in a crème sandwich cookie as a filler fat in the crème filling and as a shortening in the cookie, the amount of trans fat and saturated fat may be reduced from 2.5 grams and 1.5 grams per serving to 0 grams and 0.4 grams per serving respectively.

However, in some applications, use of the mesophase oil as a shortening imparts altered thermal mouthfeel properties to the food product. For instance, when using traditional shortening within some crème fillings, there may be a cooling mouthfeel effect because of the melting of the trans-unsaturated fatty acids in the shortening, which generally contain triglyceride crystals that melt easily. This cooling mouthfeel effect is also common with butterfat and cocoa butter based products, such as confectionery crèmes. When the mesophase oil composition is used as a replacement for the traditional shortening, such crème fillings may have a warm, thermal mouthfeel because the mesophase composition does not melt in the mouth.

Nevertheless, when using the mesophase oil as a shortening, it is possible to more closely replicate the cooling mouthfeel effect by adding further ingredients to the food product. For instance, the cooling, thermal mouthfeel can be replicated, in one form, through the addition of a crystalline polyol to the food product. The use of the polyol crystal, which generally melts in the mouth, typically replicates the mouthfeel of the traditional shortening. Preferably, erythritol or xylitol is the polyol selected to impart such cooling mouthfeel effects. Erythritol or xylitol, when delivered as crystals in the mesophase fat matrix, are generally able to mimic or replicate the same mouthcooling effects of the fat crystals in the traditional shortening. Other polyols may be used as well, such as sorbitol or maltitol, depending on the desired cooling effect because these compounds impart varied levels of cooling when used in the food product. Generally, the amount of the polyol added to achieve the desired effect is in the range of about 10 to about 20 percent. The addition of polyol may also provide a reduction of calories and a reduction in high glycemic index carbohydrates.

Advantages and embodiments of this invention are further illustrated by the following examples, but the particular materials and amounts thereof recited in these examples, as well as other conditions and details, should not be construed to unduly limit this invention. All percentages are by weight unless otherwise indicated.

### EXAMPLE 1

This example illustrates the effect of emulsifier type on the matrix stability and strength. Three types of emulsifiers were used in 90% high-oleic canola oil (Clear Valley 65, Cargill). Clear Valley 65 contains 6% saturated fatty acids (18:0+16:0), 65% monounsaturated fatty acids (18:1) and 25% polyunsaturated fatty acids (18:2+18:3). It has higher stability than typical canola oil because it contains less 18:3 (linolenic acid, 3% vs. 10%). The three emulsifiers tested were: sodium stearoyl lactylate (SSL; high HLB value) (Paniplex-K, ADM), diacetytartaric esters of monoglycerides (DATEM, intermediate HLB value) (Panodan 150K, Danisco), and distilled monoglycerides (MG/DG; low HLB value) (Dimodan HSK-A, Danisco).

The selected emulsifiers were mixed into about 200 grams of the oil. The oil/emulsifier composition was then heated in a microwave for about 3 minutes to melt the emulsifiers. After heating, the composition was cooled to ambient temperatures to form the mesophase matrix.

The strength of the mesophase matrix and comments on the stability of the structure are illustrated in Table 1 below. Gel strength was measured with a TA-XT2 Texture Analyzer (Texture Technologies Corporation, Scarsdale N.Y.) equipped with a ½ inch round probe penetrating to a depth of 10 mm. Gel strength is measured in terms of the force needed to penetrate to the given depth.

TABLE 1
Emulsifier type and gel strength

| | | | | | Gel | |
|---|---|---|---|---|---|---|
| | | | | | Strength | |
| | | | | | (grams) | |
| | | | | | (Measurement | |
| | | | | | was | |
| | | | | | made on | Comments (samples |
| | | | | | unstirred | were stirred gently |
| Sample | SSL | DATEM | MG/DG | Oil | gel | with a spatula) |
| 1 | 10% | — | — | 90% | 30.1 | Breaks when stirred. |
| 2 | — | 10% | — | 90% | 19.0 | Pourable gel when |
| | | | | | | stirred |
| 3 | — | — | 10% | 90% | 269 | pourable gel when |
| | | | | | | stirred |
| 4 | 5% | 5% | — | 90% | 57.7 | Oily, breaks, |
| | | | | | | separates |
| 5 | — | 5% | 5% | 90% | 751 | Pourable when stirred |
| 6 | 5% | — | 5% | 90% | 238 | Softened but |
| | | | | | | remained gelled when |
| | | | | | | stirred |
| 7 | 3.3% | 3.3% | 3.4% | 90% | 226 | Remains firm gel |

### EXAMPLE 2

This example illustrates the effect of varying the ratio of emulsifiers in the emulsifier mixture. For this example, only mixtures of SSL and MG/DG were used. Mesophase oil compositions were prepared as in Example 1 using 10% total emulsifier mixture and 90% of the high-oleic canola oil. Table 2 below illustrated the gel strength and comments on various ratios of the emulsifiers.

TABLE 2
Emulsifier ratio and gel strength

| | | | | Ratio | Gel | Comments (samples |
|---|---|---|---|---|---|---|
| | | | | (MG/ | Strength | were stirred gently |
| Sample | SSL | MG/DG | Oil | SSL) | (grams) | with a spatula) |
| 1 | 2.5% | 7.5% | 90% | 3.0 | 639 | Became soft when |
| | | | | | | stirred |
| 2 | 3.3% | 6.7% | 90% | 2.0 | 445 | Softened but remained |
| | | | | | | gelled when stirred |
| 3 | 5.0% | 5.0% | 90% | 1.0 | 238 | Softened but remained |
| | | | | | | gelled when stirred |
| 4 | 6.7% | 3.3% | 90% | .5 | 199 | Became soft when |
| | | | | | | stirred |
| 5 | 7.5% | 2.5% | 90% | 0.33 | 901 | Became runny and |
| | | | | | | pourable when stirred |

The gel did soften when it was stirred, but still remained an acceptable shortening plastic gel.

While the highest gel strengths were achieved with ratios of 3:1 or 1:3 of MG/DG to SSL these gels had a tendency to become runny or overly soft when stirred. The best compromise between stability and gel strength were the samples having a ratio of 1:1 to 2:1 of MG/DG to SSL. These samples broke down the least upon stirring and retained a reasonable gel strength.

### EXAMPLE 3

This example illustrates the effect of total emulsifier level on gel strength. Similar to example 2, only mixtures of SSL and MG/DG were used. In this example the ratio of emulsifiers was held constant at a ratio of 1:1. Mesophase compositions were prepared as in Example 1 using between 4% and 15% total emulsifier mixture. The level of the high-oleic canola oil was altered according to the amount of emulsifier. Table 3 below illustrates the gel strength of each emulsifier level. In general, the data in table 3 suggests that increasing the level of emulsifier increases the gel strength.

TABLE 3
Emulsifier ratio and gel strength

| | | | Gel | Comments (samples |
|---|---|---|---|---|
| | | | Strength | were stirred gently |
| Sample | Emulsifier | Oil | (grams) | with a spatula) |
| 1 | 4% | 96% | 7.15 | Stable |
| 2 | 7% | 93% | 51.9 | Stable |
| 3 | 10% | 90% | 238 | Stable |
| 4 | 15% | 85% | 859 | Stable |

### EXAMPLE 4

This example illustrates the use of a mesophase oil composition in a food product with and without an added polyol. A mesophase oil composition having 5% SSL, 5% MG/DG, and 90% high-oleic canola oil was prepared as in Example 1. Two different crème fillings were prepared according to the formulas in Table 4 below. The products were the same except that sample A did not comprise a polyol and sample B included 15% erythritol.

The crème filling was prepared by dry blending the dry ingredients, melting the mesophase oil composition, and creaming the dry ingredients into the melted composition to form a paste. The paste was then refined using a three-roll refiner, which had the final roller set at a medium gap, so that the final particle size of the refined mix was slightly grainy in the mouth.

TABLE 4
Formula for crème filling

| Ingredient | Sample A | Sample B |
|---|---|---|
| Powdered confectioners | 39.7% | 34.7% |
| sugar | | |
| Granulated sugar | 10% | — |
| Low-heat, non-fat dry milk | 20% | 20% |
| powder | | |
| Erythritol | — | 15% |
| Titanium dioxide | 0.3% | 0.3% |
| Mesophase oil composition | 30% | 30% |

The crème fillings were evaluated by several skilled tasters for mouthcooling properties. Sample A, a crème filling made without a polyol, was clean flavored and melted slowly in the mouth; however, the sample had a warm mouthfeel. Sample B, a crème filling made with an erythritol, was also clean flavored and melted slowly in the mouth, but had a mouthcooling effect that felt like a typical confectionary fat.

### EXAMPLE 5

This example illustrates the use of different polyols in a food product. A mesophase oil composition having 3.5% SSL, 3.5% MG/DG, and 93% high-oleic canola oil was prepared as in Example 1. Five different crème fillings were prepared according to the formula in Table 5 below. The products were the same except that each sample used a different polyol. For this example, sucrose, erythritol, xylitol, sorbitol, and maltitol were used as the polyol ingredient in the food product.

The crème fillings were prepared as in Example 4. Five different crème fillings were prepared, and each filling had a different polyol ingredient. The samples were all allowed to harden at least overnight before sensory evaluation.

TABLE 5
Formula for creme filling

| Ingredient | (%) |
|---|---|
| Powdered sugar (10x) | 28.2 |
| Granulated sugar | 6.6 |
| Low-heat, non-fat dry milk | 19.9 |
| powder | |
| Polyol | 15 |
| Titanium dioxide | 0.3 |
| Mesophase oil composition | 30 |

The crème fillings were evaluated for mouthcooling using a seven-point sensory evaluation scale: one being very warm and seven being very cool. Thirteen subjects participated in the evaluation and tested the five samples in random order and compared such samples to a control. The results of the survey are illustrated below in Table 6. In general, the mouthfeel of the sucrose, sorbitol, and maltitol were similar, but slightly warmer than a traditional confectionary fat. The mouthfeel of the erythritol and xylitol were cooler than the sucrose, sorbitol, and maltitol, but more similar to the confectionary fat.

TABLE 6
Sensory evaluation of crème fillings

| Polyol Ingredient | Mean |
|---|---|
| Sucrose | 3.4 |
| Erythritol | 4.5 |
| Xylitol | 4.2 |
| Sorbitol | 3.7 |
| Maltitol | 3.5 |

### EXAMPLE 6

This example illustrates the use of emulsifier blends to create a mesophase fat that can be used to replace highly saturated lauric fats for confectionery and binder applications. Typical compound coating fats contain about 90% saturated fat. For example, coconut oil contains about 92% saturated fat. Palm kernel oil contains about 88% saturated fat. A series of mesophase fats was prepared as in Example 1 using blends of palm oil (Sans Trans 39, Loders Croklaan), high oleic canola oil (Clear Valley 65, Cargill), SSL (Emplex, American Ingredients), and MG/DG (Dimodan HS-KA, Danisco) according to Table 7.

| | Sample A | Sample B | Sample C |
|---|---|---|---|
| Clear Valley 65 High | 0% | 20% | 40% |
| Oleic Canola Oil | | | |
| Sans Trans 39 Palm | 90% | 70% | 50% |
| Oil | | | |
| SSL (Emplex) | 3% | 3% | 3% |
| MG/DG (Dimodan | 7% | 7% | 7% |
| HS-KA) | | | |
| Total Saturated Fat | 53% | 44% | 35% |

The mesophase fats were used to replace a coconut/palm kernel oil blend containing 90% saturated fat in the binder of a nutritional bar. Samples A and B were highly acceptable as a binder fat comparable with the coconut/palm kernel oil blend, while Sample C resulted in a softer bar.

### EXAMPLE 7

This example illustrates the use of emulsifier blends to create a mesophase that adds structural stability to a trans-free saturated fat used as a filler crème. A blend of 96% palm oil (Sans Trans 39), 1% SSL (Emplex), and 3% MG/DG (Dimodan HS-KA) was prepared as in Example 1. The mesophase fat was used to replace 100% palm oil in the preparation of a crème filling containing 65% powdered sugar and 35% lipid component. Sandwich cookies were prepared with both crème fillings. The cookies made with the mesophase stabilized fat were found to survive shipping tests designed to simulate transport via truck at elevated temperatures, while the cookies made without the mesophase showed breakage of the cookies and compression of the filling.

### EXAMPLE 8

Shortbread cookies were prepared using a mesophase shortening and a commercial bakery shortening (Crisco, Procter and Gamble). Mesophase was made with 5% MG/DG. 5% SSL, and 90% high oleic canola oil.

Ingredients/Procedure:

1 c. sugar
1 c. mesophase or (#6)
3 c. all purpose flour
1 t. vanilla extract

Preheat oven to 350 degrees F. Mix shortening and sugar. Add vanilla. Add flour. When thoroughly mixed, spread with a rolling pin. Cut the dough in small rounds (2 inches) and shape with hands to form patties. Place on cookie sheet covered with waxed paper and bake for 20-25 minutes.

The mesophase dough was a slightly drier than the control (crumbled a bit more), but it still rolled out almost as easily as the control. The cookies were uniform in color (medium brown) but darker brown than the control.

### EXAMPLE 9

Pizza doughs for rising crust microwavable frozen pizzas were made with the following formulas (% as is):

| | Formulas: | | | |
|---|---|---|---|---|
| Ingredients | #13 | #14 | #20 | #21 |
| Bread flour | 56.98 | 56.98 | 56.98 | 56.98 |
| Compressed yeast | 2.28 | 2.28 | 2.28 | 2.28 |
| Salt | 0.85 | 0.85 | 0.85 | 0.85 |
| Sugar | 3.42 | 3.42 | 3.42 | 3.42 |
| Cold water | 30.77 | 30.77 | 30.77 | 30.77 |
| Diacetyl Esters of Monoglycerides | 0.28 | | | |
| Dimodan HS-KA | | | 0.28 | |
| Sodium Steroyl Lactylate | 0.28 | | 0.28 | |
| Canola Oil | 5.13 | | | |
| Soybean Oil | | | 5.13 | |
| Mesophase fat #6 | | 5.70 | | |
| Mesophase fat #7 | | | | 5.70 |

Mesophase fat #6 consisted of 5% SSL, 5% Dimodan HS-KA, and 90% canola oil.
Mesophase fat #7 consisted of 5% SSL, 5% Dimodan HS-KA, and 90% soybean oil.

Cheese pizzas were made with the doughs and tasted. The descriptions follow:

| | | 15 minutes |
|---|---|---|
| Formula # | 2 minutes after microwaving | after microwaving |
| #13, aged 1 | Slight off-flavor, chewy rim, | Tough, dry, drier |
| day | similar to #14 texture, rim | than #14 |
| | tougher than #14 | |
| #14, aged 1 | Off-flavor, softer than #13, | Dry, not as tough as #13, |
| day | firmer, harder bite than #13 | chewier than #13 |
| #20, aged 1 | Chewy, but not as bad as #21, | Somewhat tough on rim, |
| day | good spring back on rim, | more dry than #21 |
| | softer than #21 | |
| #21, aged 1 | Tougher and more dry than | Slightly more dry on rim |
| day | #20, chewier than #20 | than #20, not as tough as |
| | | #20, better texture than #20 |

Though there were minor differences detected between samples, all were judged to be acceptable.

Texture analysis of pizza crusts was performed at 2 minutes and 15 minutes after microwaving.

Texture of # 14 (containing mesophase fat) required significantly less force to puncture than #13 (mesophase fat components) at 2 minutes, but results were the same at 15 minutes after microwaving.

What is claimed is:

1. A fat composition comprising:
an oil phase; and
an emulsifier mixture comprising a first emulsifier having a low HLB value between about 2 and about 6 and a second emulsifier having a high HLB value between about 9 and about 22 wherein the ratio of the low HLB emulsifier to the high HLB emulsifier is from about 1:3 to about 3:1.

2. The fat composition of claim 1, wherein the oil phase comprises more mono-saturated fatty acids than either poly-unsaturated fatty acids or saturated fatty acids.

3. The fat composition of claim 2, wherein the oil phase is selected from the group consisting of high-oleic canola oil and high oleic sunflower oil.

4. The fat composition of claim 1, wherein the fat composition comprises at least about 3% of the first emulsifier and at least about 1% of the second emulsifier.

5. The fat composition of claim 4, further comprising between about 3% and about 10% of the first emulsifier.

6. The fat composition of claim 4, further comprising between about 1% and about 7% of the second emulsifier.

7. The fat composition of claim 1, wherein the low HLB emulsifier is selected from the group consisting of distilled monoglycerides, mono- and diglyceride blends and lactic acid esters of mono- and diglycerides.

8. The fat composition of claim 1, wherein the high HLB emulsifier is selected from the group consisting of sodium stearoyl lactylate, calcium stearoyl lactylate and mono-, di- and tri-fatty acid esters of sucrose.

9. The fat composition of claim 1, further comprising substantially no aqueous phase.

10. The fat composition of claim 1, further comprising a gel having a strength of at least about 50 grams.

11. The fat composition of claim 10, wherein the gel strength is from about 50 grams to about 750 grams.

12. The fat composition of claim 1, further comprising less than about 5% trans-unsaturated fatty acids and less than about 20% saturated fatty acids.

13. A fat composition comprising:
an oil mixture comprising first oil having below 10% saturated fatty acid composition and a second oil having saturated fatty acid composition above 25%; and
an emulsifier mixture comprising a first emulsifier having a low HLB value between about 2 and about 6 and a second emulsifier having a high HLB value between about 9 and about 22 wherein the ratio of the low HLB emulsifier to the high HLB emulsifier is from about 1:3 to about 3:1.

14. The fat composition of claim 13, wherein the second oil phase is selected from the group consisting of lauric fats and palmitic fats.

15. The fat composition of claim 13, wherein the first oil phase is selected from the group consisting of high-oleic canola oil and high oleic sunflower oil.

16. The fat composition of claim 13, wherein the fat composition comprises at least about 3% of the first emulsifier and at least about 1% of the second emulsifier.

17. The fat composition of claim 16, further comprising between about 3% and about 10% of the first emulsifier.

18. The fat composition of claim 16, further comprising between about 1% and about 7% of the second emulsifier.

19. The fat composition of claim 13, wherein the low HLB emulsifier is selected from the group consisting of distilled monoglycerides, mono- and diglyceride blends and lactic acid esters of mono- and diglycerides.

20. The fat composition of claim 13, wherein the high HLB emulsifier is selected from the group consisting of sodium stearoyl lactylate, calcium stearoyl lactylate and mono-, di- and tri-fatty acid esters of sucrose.

21. The fat composition of claim 13, further comprising substantially no aqueous phase.

22. The fat composition of claim 13, further comprising a gel having a strength of at least about 200 grams.

23. The fat composition of claim 13, wherein the gel strength is from about 200 grams to about 1500 grams.

24. The fat composition of claim 1, further comprising less than about 5% trans-unsaturated fatty acids.

25. A food product comprising:
a crystalline polyol;
a fat composition that includes an oil phase and a mixture of emulsifiers; and
wherein the emulsifier mixture comprises a first emulsifier having a low HLB value between about 2 and about 6 and a second emulsifier having a high HLB value between about 9 and about 22 wherein the ratio of the low HLB emulsifier to the high HLB emulsifier is from about 1:1 to about 2:1.

26. The food product of claim 25, wherein the polyol is selected from the group consisting of erythritol, xylitol, sorbitol, and maltitol.

27. The food product of claim 25, wherein the oil phase comprises more mono-saturated fatty acids than poly-unsaturated fatty acids or saturated fatty acids.

28. The food product of claim 27, wherein the oil phase is selected from the group consisting of high-oleic canola oil and high oleic sunflower oil.

29. The food product of claim 25, wherein the fat composition comprises at least about 3% of the first emulsifier and at least about 1% of the second emulsifier.

30. The food product of claim 29, further comprising between about 3% and about 10% of the first emulsifier.

31. The food product of claim 29, further comprising between about 1% and about 7% of the second emulsifier.

32. The food product of claim 25, wherein the low HLB emulsifier is selected from the group consisting of distilled monoglycerides, mono- and diglyceride blends and lactic acid esters of mono- and diglycerides.

33. The food product of claim 25, wherein the high HLB emulsifier is selected from the group consisting of sodium stearoyl lactylate, calcium stearoyl lactylate and mono-, di- and tri-fatty acid esters of sucrose.

34. The food product of claim 25, further comprising substantially no aqueous phase.

35. The food product of claim 25, further comprising a gel having a strength of at least about 50 grams.

36. The food product of claim 25, further comprising less than about 5% trans-unsaturated fatty acids and less than about 20% saturated fatty acids.

37. A method of forming a fat composition comprising:
combining an emulsifier mixture with at least one oil to form an oil composition;
heating the oil composition to a temperature effective for melting the emulsifier mixture to form a blended oil composition; and
cooling the blended oil composition to form a mesophase;
wherein the emulsifier mixture comprises a first emulsifier having a low HLB value between about 2 and about 6 and a second emulsifier having a high HLB value between about 9 and about 22 wherein the ratio of the low HLB emulsifier to the high HLB emulsifier is from about 1:3 to about 3:1.

38. The method of claim 37, wherein the at least one oil comprises more mono-saturated fatty acids than poly-unsaturated fatty acids or saturated fatty acids.

39. The method of claim 38, wherein the at least one oil is selected from the group consisting of high-oleic canola oil and high oleic sunflower oil.

40. The method of claim 37, wherein the fat composition comprises at least about 3% of the first emulsifier and at least about 1% of the second emulsifier.

41. The method of claim 40, further comprising between about 3% and about 10% of the first emulsifier.

42. The method of claim 40, further comprising between about 1% and about 7% of the second emulsifier.

43. The method of claim 37, wherein the low HLB emulsifier is selected from the group consisting of distilled monoglycerides, mono- and diglyceride blends and lactic acid esters of mono- and diglycerides.

44. The method of claim 37, wherein the high HLB emulsifier is selected from the group consisting of sodium stearoyl lactylate, calcium stearoyl lactylate and mono-, di- and tri-fatty acid esters of sucrose.

45. The method of claim 25, further comprising substantially no aqueous phase.

46. The method of claim 25, further comprising a gel having a strength of at least about 50 grams.

47. The method of claim 13, further comprising less than about 5% trans-unsaturated fatty acids and less than about 20% saturated fatty acids.
